(19) United States
(12) Patent Application Publication
(10) Pub. No.: US 2024/0043314 A1
(43) Pub. Date: Feb. 8, 2024

(54) TEMPERED GLASS PLATE

(71) Applicant: Nippon Electric Glass Co., Ltd., Shiga (JP)

(72) Inventors: Yuta NAGANO, Shiga (JP); Atsushi TANAKA, Shiga (JP); Miyako TAKEDA, Shiga (JP); Yusuke SHIMIZU, Shiga (JP)

(21) Appl. No.: 18/265,843

(22) PCT Filed: Dec. 21, 2021
(86) PCT No.: PCT/JP2021/047223

§ 371 Date: Jun. 7, 2023

(30) Foreign Application Priority Data
Dec. 28, 2020 (JP) 2020-218403

(51) Int. Cl. C03C 3/083

(52) U.S. Cl. CPC C03C 3/083; C03C 2204/00

(57) ABSTRACT

A tempered glass sheet according to an embodiment of the present invention has a compressive stress layer on a surface of the tempered glass sheet, in which a compressive stress value on the outermost surface of the compressive stress layer is 200 MPa or higher, and a bending strain is 30×10⁻⁴ or less.

### TECHNICAL FIELD

The present invention relates to a tempered glass sheet and more particularly to a tempered glass sheet suitable for a cover member of a foldable display or the like.

### BACKGROUND ART

In recent years, foldable displays, which are bendable, have appeared on the market. In foldable displays, a cover member formed by laminating a resin and a tempered glass sheet is used.

For the tempered glass sheet, an ion-exchange-treated tempered glass sheet is typically used (see Patent Documents 1 and 2 and Non-Patent Document 1).

### CITATION LIST

### Patent Document

Patent Document 1: JP 2006-083045 A
Patent Document 2: WO 2015/031188

### Non-Patent Document

Non-Patent Document 1: Tetsuro Izumitani et al., “Atarashii Garasu to Sono Bussei (New Glass and Its Physical Properties)”, First Edition, Management System Laboratory. Co., Ltd., Aug. 20, 1984, p. 451-498

### SUMMARY OF INVENTION

### Technical Problem

A cover member of a foldable display is used in a bent state. However, holding the cover member in a bent state for a certain period of time may reduce the visibility of the bent portion of the tempered glass sheet after releasing the holding state.

In addition, a tempered glass sheet to be used in a cover member is required to have a high compressive stress value on the outermost surface. A tempered glass sheet with a high compressive stress value on the outermost surface makes it easier to prevent breakage due to tensile stress generated in the bent portion of the tempered glass sheet when the foldable display is bent.

The present invention has been made in view of the above circumstances, and a technical object of the present invention is to provide a tempered glass sheet that is less likely to reduce the visibility of its bent portion and has a high compressive stress value on the outermost surface.

### Solution to Problem

As a result of diligent study, the present inventors have found that the decrease in the visibility of the bending portion of the tempered glass sheet is due to the bending strain, and that the above technical object can be solved by controlling the compressive stress value on the outermost surface to a predetermined value or greater and controlling the bending strain to a predetermined value or less, and propose the present invention. That is, a tempered glass sheet according to an embodiment of the present invention is a tempered glass sheet including a compressive stress layer on its surface, the tempered glass sheet having a compressive stress value on the outermost surface of the compressive stress layer of 200 MPa or higher and a bending strain of 30×10⁻⁴ or less.

“Bending strain” refers to a value obtained by placing a fibrous glass (evaluation sample) with a length of 150 mm and a φ of 0.13 mm in a state of maintaining a U-shape between two support plates with a plate-to-plate distance set to 26 mm, holding the evaluation sample at room temperature for 90 hours, then removing the evaluation sample from between the support plates to release the holding state, further allowing the evaluation sample to stand at room temperature for 10 minutes, and then calculating the bending strain generated in the bent portion of the evaluation sample by Equation 1 below in accordance with JIS K 7116 (see FIG. 1).

Bending strain=(6×St×d)/(L²) [Equation 1]
St: a distance between a midpoint and an intersection of two tangent lines, the midpoint between two base points, the two tangent lines drawn from the two base points along an arc
d: a fiber diameter (0.13 mm) of the evaluation sample
L: a distance between two base points

“Compressive stress value on the outermost surface of the compressive strain layer” can be calculated from the number of interference fringes and intervals between the fringes observed using a surface stress meter (FSM-6000 available from Orihara Manufacturing Co., Ltd.).

The tempered glass sheet according to an embodiment of the present invention preferably has a compressive stress value of 500 to 1200 MPa on the outermost surface of the compressive stress layer.

The tempered glass sheet according to an embodiment of the present invention preferably has a sheet thickness of 100 μm or less.

The tempered glass sheet according to an embodiment of the present invention preferably contains as glass composition in mol % from 40 to 80% of SiO₂, from 5 to 25% of Al₂O₃, from 0 to 30% of B₂O₃, from 0 to 25% of Li₂O, from 0 to 25% of Na₂O, from 0 to 25% of K₂O, from 0 to 20% of MgO, from 0 to 10% of ZnO, from 0 to 15% of P₂O₅, and from 0 to 1% of SnO₂.

The tempered glass sheet according to an embodiment of the present invention preferably has a stress depth of the compressive stress layer of 10 to 30% of the sheet thickness.

The tempered glass sheet according to an embodiment of the present invention preferably has a softening point of 950° C. or lower. As used herein, “softening point” refers to a value measured by the method of ASTM C338.

Furthermore, the tempered glass sheet according to an embodiment of the present invention preferably has a temperature of lower than 1650° C. at a high-temperature viscosity of 10^{2.5} dPa·s. As used herein “temperature at a high-temperature viscosity of 10^{2.5} dPa·s” refers to a value measured by the platinum ball pulling-up method.

The tempered glass sheet according to an embodiment of the present invention preferably has a dimension of □50 mm or greater.

The tempered glass sheet according to an embodiment of the present invention preferably has an overflow-joining surface in the central portion in the sheet thickness direction, that is, the tempered glass sheet is preferably formed by a down-draw method.

The tempered glass sheet according to an embodiment of the present invention is preferably for use in a cover member of a foldable display.

The tempered glass sheet according to the present invention is a tempered glass sheet having a compressive stress layer on a surface of the tempered glass sheet, wherein a compressive stress value on the outermost surface of the compressive stress layer is preferably 200 MPa or higher, a sheet thickness is preferably 100 μm or less, and a bending angle is preferably 30° or less. As used herein, “bending angle” refers to a value obtained by placing a glass sheet (evaluation sample) in a state of maintaining a U-shape between two support plates with a plate-to-plate distance set to 26 mm, holding the evaluation sample at room temperature for 90 hours, then removing the evaluation sample from between the support plates to release the holding state, further allowing the evaluation sample to stand at room temperature for 10 minutes, and then measuring the bending angle generated in the bent portion of the evaluation sample.

Moreover, a glass sheet to be tempered according to an embodiment of the present invention is an ion-exchangeable glass sheet to be tempered and has a bending strain of 30×10⁻⁴ or less.

### BRIEF DESCRIPTION OF DRAWINGS

FIG. 1 is an explanatory diagram for explaining an evaluation method for bending strain.

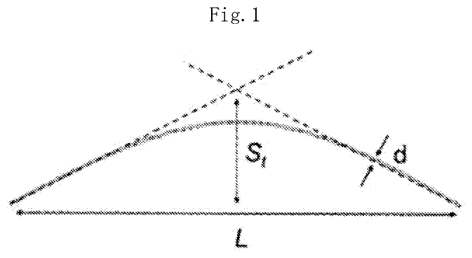

### DESCRIPTION OF EMBODIMENTS

In a tempered glass sheet (glass sheet to be tempered) according to an embodiment of the present invention, bending strain is preferably 30×10⁻⁴ or less, 25×10⁻⁴ or less, 20×10⁻⁴ or less, 15×10⁻⁴ or less, 10×10⁻⁴ or less, 8×10⁻⁴ or less, 5×10⁻⁴ or less, 4×10⁻⁴ or less, 3×10⁻⁴ or less, 2.5×10⁻⁴ or less, 2.4×10⁻⁴ or less, 2.3×10⁻⁴ or less, 2.2×10⁻⁴ or less, 2.1×10⁻⁴ or less, 2×10⁻⁴ or less, 1.9×10⁻⁴ or less, 1.8×10⁻⁴ or less, 1.7×10⁻⁴ or less, 1.6×10⁻⁴ or less, 1.5×10⁻⁴ or less, 1.4×10⁻⁴ or less, 1.3×10⁻⁴ or less, 1.2×10⁻⁴ or less, 1.1×10⁻⁴ or less, 1×10⁻⁴ or less, 0.9×10⁻⁴ or less, 0.8×10⁻⁴ or less, 0.7×10⁻⁴ or less, 0.6×10⁻⁴ or less, and particularly 0.5×10⁻⁴ or less. Too high a bending strain may reduce the visibility of the foldable display.

In the tempered glass sheet (glass sheet to be tempered) according to an embodiment of the present invention, a bending angle is preferably 30° or less, 25° or less, 24° or less, 23° or less, 22° or less, 21° or less, 20° or less, 19° or less, 18° or less, 17° or less, 16° or less, 15° or less, 14° or less, 13° or less, 12° or less, 11° or less, 10° or less, 9° or less, 8° or less, 7° or less, 6° or less, 5° or less, 4° or less, 3° or less, 2° or less, and particularly 1° or less. Too large a bending angle may reduce the visibility of the foldable display.

The tempered glass sheet (glass sheet to be tempered) according to an embodiment of the present invention contains as glass composition in mol % from 40 to 80% of SiO₂, from 5 to 25% of Al₂O₃, from 0 to 30% of B₂O₃, from 0 to 25% of Li₂O, from 0 to 25% of Na₂O, from 0 to 25% of K₂O, from 0 to 20% of MgO, from 0 to 10% of ZnO, from 0 to 15% of P₂O₅, and from 0 to 1% of SnO₂. The reason for limiting the content range of each component in the tempered glass sheet according to an embodiment of the present invention will be described below. In the descriptions of the content range of each component, “%” refers to “mol %” unless otherwise specified.

SiO₂ is a component that forms the network of the glass. Too low a content of SiO₂ may make the vitrification difficult. Thus, a suitable lower limit range of SiO₂ is 40% or more, 50% or more, 52% or more, 54% or more, 55% or more, 57% or more, 59% or more, 60% or more, 61% or more, 62% or more, 63% or more, and particularly 64% or more. On the other hand, too high a content of SiO₂ may likely reduce the meltability and formability, and in addition, excessively reduce the thermal expansion coefficient and thus make it difficult to match the thermal expansion coefficient of the peripheral material. Thus, a suitable upper limit range of SiO₂ is 80% or less, 75% or less, 73% or less, 71% or less, 70% or less, 69% or less, 68% or less, 67% or less, 66% or less, and particularly 65% or less.

Al₂O₃ is a component that enhances the ion-exchange performance and is also a component that reduces the bending strain. Too low a content of Al₂O₃ may likely reduce the ion-exchange performance and likely increase the bending strain. Thus, a suitable lower limit range of Al₂O₃ is 5% or more, 6% or more, 7% or more, 8% or more, 9% or more, 10% or more, and particularly 11% or more. On the other hand, too high a content of Al₂O₃ may likely precipitate devitrified crystals in the glass and make it difficult to form the glass into a sheet shape by an overflow down-draw method or the like. In particular, when an alumina refractory is used as a compact refractory to form the glass into a sheet shape by an overflow down-draw method, too high a content of Al₂O₃ may likely precipitate devitrified crystals of spinel at the interface with the alumina refractory. Thus, a suitable upper limit range of Al₂O₃ is 25% or less, 24% or less, 23% or less, 22% or less, 21% or less, 20% or less, 19% or less, 18% or less, 17% or less, 16% or less, 15% or less, 13.5% or less, 13% or less, and particularly 12% or less.

B₂O₃ is a component that reduces the high-temperature viscosity and density as well as increases the devitrification resistance. However, too high a content of B₂O₃ may likely reduce the ion-exchange rate (in particular, stress depth). In addition, the ion exchange may cause coloration of the glass surface called “burn,” likely increase the bending strain, and likely reduce acid resistance and water resistance. Thus, a suitable lower limit range of B₂O₃ is 0% or more, 0.1% or more, 0.5% or more, 1% or more, 2% or more, 3% or more, 4% or more, 5% or more, 6% or more, 7% or more, 8% or more, 9% or more, and particularly 10% or more. In addition, a suitable upper limit range of B₂O₃ is 30% or less, 25% or less, 22% or less, 20% or less, 18% or less, 16% or less, 13% or less, 12% or less, 11% or less, 10.5% or less, and particularly 10% or less.

Alkali metal oxides are ion-exchange components and are also components that reduce the high-temperature viscosity to increase the meltability or formability. However, too high a content of alkali metal oxides ([Li₂O]+[Na₂O]+[K₂O]) may increase the bending strain and the thermal expansion coefficient. Thus, a suitable lower limit range of alkali metal oxides ([Li₂O]+[Na₂O]+[K₂O]) is 1% or more, 2% or more, 3% or more, 4% or more, 5% or more, 6% or more, 7% or more, 8% or more, 9% or more, 10% or more, 11% or more, 12% or more, 13% or more, 14% or more, 15% or more, and particularly 16% or more, and a suitable upper limit range is 25% or less, 24% or less, 23% or less, 22% or less, 21% or less, 20% or less, 19% or less, 18% or less, and particularly 17% or less. Here, [Li₂O] represents the content (mol %) of Li₂O, [Na₂O] the content (mol %) of Na₂O, and [K₂O] the content (mol %) of K₂O.

Li₂O is an ion-exchange component, in particular, a component useful for obtaining a large stress depth, and is also a component that reduces the high-temperature viscosity to increase the meltability and formability. On the other hand, Li₂O is a component that increases the bending strain and is also a component that is eluted during the ion-exchange treatment and deteriorates the ion-exchange solution. Thus, a suitable content of Li₂O is from 0 to 25%, from 0 to 20%, from 0 to 15%, from 0 to 13%, from 0 to 10%, from 0 to 7%, from 0 to 5%, from 0 to less than 3%, from 0 to 2%, and particularly from 0 to 1%. When Li₂O is added, a suitable lower limit range of Li₂O is 0.01% or more, 0.1% or more, 0.5% or more, and particularly 1% or more.

Na₂O is an ion-exchange component and is also a component that reduces the high-temperature viscosity to increase the meltability and formability. In addition, Na₂O is also a component that improves the devitrification resistance and reduces devitrification due to reaction with a compact refractory, particularly with an alumina refractory. Too low a content of Na₂O may reduce the meltability, excessively reduce the thermal expansion coefficient, and likely reduce the ion-exchange rate. Thus, a suitable lower limit range of Na₂O is 0% or more, 1% or more, 5% or more, 6% or more, 7% or more, 8% or more, 9% or more, 10% or more, 11% or more, 12% or more, and particularly 13% or more. On the other hand, too high a content of Na₂O may increase the bending strain; and may also eliminate the component balance of the glass composition, and this may rather reduce the devitrification resistance. Thus, a suitable upper limit range of Na₂O is 25% or less, 22% or less, 20% or less, 19.5% or less, 19% or less, 18% or less, 17% or less, 16.5% or less, 16% or less, 15.5% or less, and particularly 15% or less.

K₂O is a component that reduces the high-temperature viscosity to increase the meltability and formability, and also a component that improves the devitrification resistance. However, too high a content of K₂O may increase the bending strain; and may also eliminate the component balance of the glass composition, and this may tend to rather reduce the devitrification resistance. Thus, a suitable upper limit range is 25% or less, 20% or less, 15% or less, 13% or less, 10% or less, 8% or less, 6% or less, 4% or less, 3% or less, 2% or less, 1% or less, 0.1% or less, and particularly less than 0.1%.

MgO is a component that reduces the high-temperature viscosity to increase the meltability and formability. However, too high a content of MgO may tend to reduce the ion-exchange performance and devitrify the glass. In particular, when an alumina refractory is used as a compact refractory to form the glass into a sheet shape by an overflow down-draw method, too high a content of MgO may likely precipitate devitrified crystals of spinel at the interface with the alumina refractory. Thus, a suitable upper limit range of MgO is 20% or less, 15% or less, 10% or less, 6% or less, 4.5% or less, 3% or less, 2% or less, 1% or less, and particularly 0.1% or less.

ZnO is a component that enhances the ion-exchange performance and, in particular, is a component that has a large effect of increasing the compressive stress value. In addition, ZnO is also a component that reduces the high-temperature viscosity without reducing the low-temperature viscosity. However, too high a content of ZnO may tend to phase-separate the glass, reduce the devitrification resistance, increase the density, and reduce the stress depth. Thus, a suitable content of ZnO is from 0 to 10%, from 0 to 6%, from 0 to 3%, and particularly from 0 to 1%.

P₂O₅ is a component that maintains the compressive stress value and enhances the ion-exchange performance, and also reduces the bending strain. Furthermore, P₂O₅ is a component that reduces the high-temperature viscosity to increase the meltability and formability. However, too high a content of P₂O₅ may likely cause white cloudiness in the glass due to phase separation and reduce acid resistance. Thus, a suitable upper limit range of P₂O₅ is 15% or less, 12% or less, 10% or less, 8% or less, 6% or less, 5% or less, 4% or less, 3% or less, 2% or less, 1% or less, 0.5% or less, and particularly 0.1% or less. When P₂O₅ is added, a suitable lower limit range of P₂O₅ is 0% or more, 0.1% or more, 0.5% or more, 1% or more, 2% or more, and particularly 3% or more.

Too high or too low a content of [Li₂O]+[Na₂O]+[K₂O]−[Al₂O₃]−[B₂O₃]−[P₂O₅] may increase the bending strain. Thus, a suitable range of [Li₂O]+[Na₂O]+[K₂O]−[Al₂O₃]−[B₂O₃]−[P₂O₅] is from −30 to 20%, from −25 to 18%, from −20 to 15%, from −15 to 13%, from −10 to 10%, from −9 to 9%, from −8 to 8%, from −7 to 7%, from −6 to 6%, from −5 to 5%, from −4 to 4%, from −3 to 3%, from −2 to 2%, from −1.5 to 1.5%, from −1 to 1%, and particularly from −0.5 to 0.5%.

SnO₂ is a component that acts as a fining agent. A suitable content of SnO₂ is from 0 to 1%, from 0.001 to 1%, from 0.05 to 1%, from 0.10 to 0.5%, and particularly from 0.10 to 0.30%.

In addition to the above components, a component, such as the following, may be added.

CaO is a component that reduces the high-temperature viscosity to increase the meltability and formability without reducing the devitrification resistance compared with other components. However, too high a content of CaO may likely reduce the ion-exchange performance and deteriorate the ion-exchange solution. Thus, a suitable content of CaO is from 0 to 6%, from 0 to 5%, from 0 to 4%, from 0 to 3.5%, from 0 to 3%, from 0 to 2%, from 0 to 1%, and particularly from 0 to 0.5%.

SrO and BaO are components that reduce the high-temperature viscosity to increase the meltability and formability. However, too high a content of SrO or BaO may likely reduce the ion-exchange performance, increase the density or thermal expansion coefficient, and devitrify the glass. Thus, suitable contents of ScO and BaO are each preferably from 0 to 2%, from 0 to 1.5%, from 0 to 1%, from 0 to 0.5%, from 0 to 0.1%, and particularly from 0 to less than 0.1%.

The combined amount of CaO, SrO, and BaO is preferably from 0 to 5%, from 0 to 2.5%, from 0 to 2%, from 0 to 1.5%, from 0 to 1%, from 0 to 0.5%, from 0 to 0.1%, and particularly from 0 to less than 0.1%. Too high a combined amount of CaO, SrO, and BaO may likely reduce the ion-exchange performance.

TiO₂ is a component that enhances the ion-exchange performance and is also a component that reduces the high-temperature viscosity. However, too high a content of TiO₂ may likely color or devitrify the glass. Thus, the content of TiO₂ is preferably from 0 to 4.5%, from 0 to less than 1%, from 0 to 0.5%, and particularly from 0 to 0.3%.

ZrO₂ is a component that significantly enhances the ion-exchange performance and increases the viscosity at or near the liquid phase viscosity and the strain point. However, too high a content of ZrO₂ may significantly reduce the devitrification resistance and excessively increase the density. Thus, a suitable content of ZrO₂ is from 0 to 5%, from 0 to 4%, from 0 to 3%, from 0 to 2%, and particularly from 0 to less than 0.1%.

Fe₂O₃ is an impurity component from a raw material but a component that absorbs ultraviolet light that adversely affects the human eye. However, too high a content of Fe₂O₃ may strengthen the coloration of the glass. Thus, a suitable content of Fe₂O₃ is less than 1000 ppm (0.1%), less than 800 ppm, less than 600 ppm, less than 400 ppm, less than 300 ppm, less than 250 ppm, less than 200 ppm, less than 150 ppm, and particularly less than 100 ppm.

Rare earth oxides, such as Nd₂O₃ and La₂O₃, are components that increase Young's modulus. However, the cost of the raw material itself is high, and adding a large amount of rare earth oxide may likely to reduce the devitrification resistance. Thus, a suitable content of a rare earth oxide is 3% or less, 2% or less, 1% or less, 0.5% or less, and particularly 0.1% or less.

From environmental considerations, the glass component preferably does not substantially contain As₂O₃, Sb₂O₃, PbO, F, or Bi₂O₃. “Does not substantially contain” means that although a specified component is not actively added as a glass component, mixing in of the specified component at an impurity level is permitted and specifically refers to the content of the specified component of less than 0.05%.

The tempered glass sheet (glass sheet to be tempered) according to an embodiment of the present invention preferably has, for example, the following properties.

The strain point is preferably 480° C. or higher, 500° C. or higher, 520° C. or higher, and particularly from 530 to 700° C. The higher the strain point, the lower is the bending strain.

The softening point is preferably 950° C. or lower, 900° C. or lower, 880° C. or lower, 860° C. or lower, and particularly from 700 to 850° C. The lower the softening point, the more improved is the thermal processability, reducing the burden on glass manufacturing equipment, such as thermal processing equipment. Thus, the lower the softening point, the easier it is to reduce the production cost of the tempered glass sheet.

The temperature at a high-temperature viscosity of 10^{2.5} dPa·s is preferably lower than 1650° C., 1630° C. or lower, 1620° C. or lower, and particularly 1610° C. or lower. The tempered glass sheet (glass sheet to be tempered) with a lower temperature at a high-temperature viscosity of 10^{2.5} dPa·s can be melted at lower temperatures, reducing the burden on glass manufacturing equipment, such as a melting furnace, and likely increasing the bubble quality. Thus, the lower the temperature at a high-temperature viscosity of 10^{2.5} dPa·s, the easier it is to reduce the production cost of the tempered glass sheet.

The liquid phase viscosity in log ρ is preferably 4.0 dPa·s or greater, 4.3 dPa·s or greater, 4.5 dPa·s or greater, 4.8 dPa·s or greater, 5.1 dPa·s or greater, 5.3 dPa·s or greater, and particularly 5.5 dPa·s or greater. Too low a liquid phase viscosity may reduce the devitrification resistance and make it difficult to produce a glass sheet to be tempered, particularly a glass sheet to be tempered with a small sheet thickness, by an overflow down-draw method or the like.

The tempered glass sheet according to an embodiment of the present invention has a compressive stress layer on the surface. The compressive stress value on the outermost surface is preferably 200 MPa or higher, 300 MPa or higher, 400 MPa or higher, 500 MPa or higher, 600 MPa or higher, and particularly 700 MPa or higher. The higher the compressive stress value on the outermost surface, the easier it is to prevent breakage due to tensile stress generated in the bent portion of the tempered glass sheet when the foldable display is bent. On the other hand, an extremely high compressive stress if formed on the surface may extremely increase the tensile stress inherent in the tempered glass and increase the dimensional change before and after ion-exchange treatment. Thus, the compressive strain value on the outermost layer is preferably 1300 MPa or less, 1100 MPa or less, 900 MPa or less, and particularly 800 MPa or less.

The stress depth is preferably 1 μm or greater, 3 μm or greater, 4 μm or greater, 5 μm or greater, 6 μm or greater, 7 μm or greater, 8 μm or greater, 9 μm or greater, and particularly 10 μm or greater. In addition, the stress depth is from 5 to 30%, from 6 to 25%, from 7 to 20%, from 8 to 17%, from 9 to 16%, from 10 to 15%, from 11 to 14%, and particularly from 12 to 13% of the sheet thickness. The greater the stress depth, the less likely is the tempered glass sheet to crack even if the tempered glass sheet has a deep scratch, and the smaller is the variation in mechanical strength. On the other hand, the greater the stress depth, the more likely is the dimensional change to be larger before and after ion-exchange treatment. Thus, the stress depth is preferably 20 μm or less, 15 μm or less, 14 μm or less, 13 μm or less, 12 μm or less, 11 μm or less, and particularly 10 μm or less.

The internal tensile stress value is preferably 400 MPa or less, 350 MPa or less, 300 MPa or less, 250 MPa or less, 220 MPa or less, 200 MPa or less, 180 MPa or less, and particularly 170 PMa or less. The tempered glass sheet with too high an internal tensile stress value may be prone to self-destruction due to physical collision or the like. On the other hand, the tempered glass sheet with too low an internal tensile stress value may have a difficulty in ensuring mechanical strength. The internal compressive stress value is preferably 20 MPa or higher, 30 MPa or higher, 40 MPa or higher, 50 MPa or higher, 60 MPa or higher, 80 MPa or higher, 100 MPa or higher, 125 MPa or higher, 140 MPa or higher, and particularly 150 MPa or higher. The internal tensile stress can be calculated by Equation 2 below.

Internal tensile stress value=(compressive stress value on outermost surface×stress depth)/(sheet thickness−2×stress depth) [Equation 2]

In the tempered glass sheet according to an embodiment of the present invention, the sheet thickness is preferably 200 μm or less, 150 μm or less, 100 μm or less, less than 100 μm, 80 μm or less, 60 μm or less, from 1 to 50 μm, from 5 to 40 μm, and particularly from 10 to 30 μm. The smaller the thickness, the more improved is the flexibility of the tempered glass sheet, facilitating the application to the foldable display. In addition, this reduces the allowable radius of curvature when the tempered glass sheet is bent and makes it easier to wind the tempered glass sheet in a roll shape.

The ratio of the sheet thickness to the compressive stress value on the outermost surface is preferably 0.5 μm/MPa or less, 0.4 μm/MPa or less, 0.3 μm/MPa or less, 0.2 μm/MPa or less, 0.15 μm/MPa or less, and particularly from 0.03 to 0.1 μm/MPa. The smaller the ratio of the sheet thickness to the compressive stress value on the outermost surface, the easier it is to prevent breakage due to tensile stress generated in the bent portion of the tempered glass sheet when the foldable display is bent. On the other hand, the tempered glass sheet with too small a ratio of the sheet thickness to the compressive stress value on the outermost surface may extremely increase the tensile stress inherent in the tempered glass sheet and be prone to self-destruction due to physical collision or the like. Thus, the ratio of the sheet thickness to the compressive stress value on the outermost surface is preferably 0.01 μm/MPa or higher, 0.015 μm/MPa or higher, 0.02 μm/MPa or higher, and particularly 0.025 μm/MPa or higher.

The product of the bending strain and the sheet thickness (value obtained by multiplying the bending strain by the sheet thickness) is preferably 500×10⁻⁴ μm or less, 400×10⁻⁴ μm or less, 300×10⁻⁴ μm or less, 250×10⁻⁴ μm or less, 200×10⁻⁴ μm or less, 150×10⁻⁴ μm or less, 100×10⁻⁴ μm or less, 90×10⁻⁴ μm or less, 80×10⁻⁴ μm or less, 70×10⁻⁴ μm or less, 60×10⁻⁴ μm or less, 50×10⁻⁴ μm or less, 40×10⁻⁴ μm or less, and particularly 30×10⁻⁴ μm or less. The tempered glass sheet with too large a product of the bending strain and the sheet thickness may likely reduce the visibility of the bent portion of the tempered glass sheet when the foldable display is bent.

The product of the bending angle and the sheet thickness (value obtained by multiplying the bending angle by the sheet thickness) is preferably 3000°·μm or less, 2500°·μm or less, 2000°·μm or less, 1500°·μm or less, 1000°·μm or less, 500°·μm or less, 400°·μm or less, 300°·μm or less, 200°·μm or less, 100°·μm or less, 90°·μm or less, 80°·μm or less, 70°·μm or less, 60°·μm or less, and particularly 50°·μm or less. The tempered glass sheet with too large a product of the bending angle and the sheet thickness may likely reduce the visibility of the bent portion of the tempered glass sheet when the foldable display is bent.

The dimension is preferably □ 50 mm or greater, □ 60 mm or greater, □ 70 mm or greater, □ 80 mm or greater, □ 90 mm or greater, □ 100 mm or greater, □ 120 mm or greater, □ 150 mm or greater, and particularly from □ 200 to 2000 mm. The tempered glass with a larger dimension is more easily applied to a large flexible display.

The glass sheet to be tempered according to an embodiment of the present invention can be produced as follows. Preferably, first, glass raw materials mixed to give a desired glass composition are placed in a continuous melting furnace, melted by heating at 1500 to 1700° C., fined, then the resulting molten glass is fed to a forming device, formed into a sheet shape, and cooled. A well-known method can be employed to cut the glass sheet into a predetermined dimension after forming the glass into a sheet shape, but the glass sheet is preferably cut by laser fusion cutting because this produces smooth end faces.

During the formation of the molten glass, the molten glass is preferably cooled at a cooling rate of 2° C./min or higher and less than 2500° C./min in the temperature range from the annealing point to the strain point of the molten glass. The cooling rate is preferably 5° C./min or higher, 10° C./min or higher, 40° C./min or higher, 60° C./min or higher, and particularly 100° C./min or higher, and preferably less than 2500° C./min, less than 2000° C./min, less than 1800° C./min, less than 1500° C./min, less than 1300° C./min, less than 1000° C./min, less than 800° C./min, and less than 500° C./min. Too low a cooling rate may make it difficult to reduce the sheet thickness. On the other hand, too high a cooling rate may make the glass structure coarse and likely reduce the hardness of the glass sheet to be tempered.

The overflow down-draw method is preferably employed to form the molten glass. The overflow down-draw method is a method that can produce high-quality glass sheets in large quantities and can easily produce thin glass sheets. Furthermore, while the overflow down-draw method uses alumina or zirconia as a compact refractory, the glass sheet to be tempered according to an embodiment of the present invention has particularly good compatibility with alumina and thus may be less likely to generate bubbles, particles, or the like during formation.

Various forming methods can be used aside from the overflow downdraw method. For example, forming methods such as a float method, a downdraw method (slot downdraw method, redraw method, etc.), a roll-out method, or a press method can be used.

The tempered glass sheet according to an embodiment of the present invention is produced by ion-exchange treatment of the glass sheet to be tempered. The conditions for the ion-exchange treatment are not particularly limited, and optimum conditions are selected in consideration of the viscosity properties, application, thickness, internal tensile stress, dimensional change, and the like of the glass. In particular, ion-exchange of K ions in a KNO₃ molten salt with a Na component in the glass can efficiently form the compressive stress layer on the surface.

The number of times of the ion-exchange treatment is not particularly limited, and the ion-exchange treatment may be performed only once or may be performed multiple times. Limiting the number of times of the ion-exchange treatment to once can reduce the cost of the tempered glass sheet. When the ion-exchange treatment is performed multiple times, the ion-exchange treatment is preferably performed twice. This can increase the stress depth and also reduce the total amount of tensile stress accumulated inside the glass.

### Example 1

The present invention will be described below based on examples. The following examples are merely exemplary. The present invention is not limited to the following examples in any way.

Tables indicate Examples of the present invention (samples Nos. 1 to 80) and Comparative Examples (samples Nos. 81 and 82).

Each sample in the tables was produced as follows. First, glass raw materials were mixed to give a glass composition presented in the tables, and the mixture was melted at 1580° C. for 8 hours using a platinum pot. The resulting molten glass was then poured onto a carbon plate, formed into a flat sheet shape, and annealed. The resulting glass sheets to be tempered were evaluated for various properties. The results are shown in the tables.

TABLE 1

| (mol %) | No. 1 | No. 2 | No. 3 | No. 4 | No. 5 | No. 6 | \|No. 7 | No. 8 | No. 9 | No. 10 | No. 11 | No. 12 |
|---|---|---|---|---|---|---|---|---|---|---|---|---|
| SiO₂ | 66.40 | 69.82 | 72.10 | 66.80 | 67.40 | 68.70 | 67.20 | 65.90 | 65.90 | 68.40 | 70.90 | 63.40 |
| Al₂O₃ | 11.50 | 8.66 | 3.50 | 10.70 | 11.10 | 10.30 | 12.70 | 12.00 | 12.00 | 12.00 | 12.00 | 12.00 |
| B₂O₃ | 0.50 | 2.27 | 9.20 | 0.00 | 0.00 | 0.00 | 3.80 | 0.00 | 0.00 | 0.00 | 0.00 | 0.00 |
| Li₂O | 0.02 | 0.03 | 0.00 | 0.00 | 0.00 | 0.00 | 0.00 | 0.00 | 0.00 | 0.00 | 0.00 | 0.00 |
| Na₂O | 15.20 | 13.65 | 10.80 | 13.00 | 15.40 | 15.30 | 13.90 | 17.00 | 14.50 | 14.50 | 12.00 | 17.00 |
| K₂O | 1.40 | 0.43 | 0.00 | 2.80 | 1.40 | 0.00 | 0.00 | 0.00 | 0.00 | 0.00 | 0.00 | 0.00 |
| MgO | 4.80 | 4.71 | 0.00 | 6.10 | 4.00 | 5.50 | 2.40 | 5.00 | 7.50 | 5.00 | 5.00 | 7.50 |
| CaO | 0.10 | 0.09 | 3.50 | 0.00 | 0.00 | 0.00 | 0.00 | 0.00 | 0.00 | 0.00 | 0.00 | 0.00 |
| SrO | 0.00 | 0.00 | 0.00 | 0.00 | 0.00 | 0.00 | 0.00 | 0.00 | 0.00 | 0.00 | 0.00 | 0.00 |
| BaO | 0.00 | 0.00 | 0.00 | 0.00 | 0.00 | 0.00 | 0.00 | 0.00 | 0.00 | 0.00 | 0.00 | 0.00 |
| P₂O₅ | 0.00 | 0.00 | 0.00 | 0.00 | 0.00 | 0.00 | 0.00 | 0.00 | 0.00 | 0.00 | 0.00 | 0.00 |
| ZrO₂ | 0.00 | 0.00 | 0.70 | 0.00 | 0.50 | 0.00 | 0.00 | 0.00 | 0.00 | 0.00 | 0.00 | 0.00 |
| SnO₂ | 0.10 | 0.15 | 0.10 | 0.05 | 0.10 | 0.20 | 0.10 | 0.10 | 0.10 | 0.10 | 0.10 | 0.10 |
| Li₂O + Na₂O + K₂O | 16.6 | 14.1 | 10.8 | 15.8 | 16.8 | 15.3 | 13.9 | 17.0 | 14.5 | 14.5 | 12.0 | 17.0 |
| Li₂O + Na₂O + | 4.6 | 3.2 | −1.9 | 5.1 | 5.7 | 5.0 | −2.6 | 5.0 | 2.5 | 2.5 | 0.0 | 5.0 |
| K₂O—Al₂O₃—B₂O₃—P₂O₅ | | | | | | | | | | | | |
| Bending strain (x 10⁻⁴) | 1.50 | 0.66 | 0.70 | 2.00 | 2.07 | 0.38 | 0.22 | 0.47 | 0.44 | 0.34 | 0.22 | 0.48 |
| Ps (° C.) | 564 | 551 | 536 | 593 | 585 | 597 | 575 | 597 | 628 | 633 | 667 | 602 |
| Ta (° C.) | 614 | 596 | 573 | 645 | 636 | 648 | 629 | 648 | 679 | 688 | 726 | 651 |
| Ts (° C.) | 866 | 829 | 743 | 892 | 882 | 893 | 905 | 886 | 917 | 943 | 997 | 875 |
| 10^{2.5} dPa · s (° C.) | 1597 | 1578 | 1345 | 1595 | 1608 | 1610 | 1686 | 1575 | 1594 | 1654 | 1721 | 1525 |
| Log η at TL (dPa · s) | 6.3 | 6.5 | 5.0 | 5.3 | 6.0 | 5.8 | 6.6 | 6.1 | Not | Not | Not | Not |
| | | | | | | | | | meas- | meas- | meas- | meas- |
| | | | | | | | | | ured | ured | ured | ured |
| CS (MPa) | 1040 | 850 | 715 | 921 | 1001 | 1013 | 984 | 1108 | Not | Not | Not | Not |
| | | | | | | | | | meas- | meas- | meas- | meas- |
| | | | | | | | | | ured | ured | ured | ured |
| DOL (μm) | 39 | 28 | 11 | 41 | 45 | 35 | 32 | 38 | Not | Not | Not | Not |
| | | | | | | | | | meas- | meas- | meas- | meas- |
| | | | | | | | | | ured | ured | ured | ured |

TABLE 2

| SiO₂ | No. 13 | No. 14 | No. 15 | No. 16 | No. 17 | \|No. 18 | No. 19 | No. 20 | No. 21 | No. 22 | No. 23 | No. 24 |
|---|---|---|---|---|---|---|---|---|---|---|---|---|
| Al₂O₃ | 68.40 | 70.90 | 65.90 | 68.40 | 65.90 | 68.50 | 66.00 | 68.40 | 65.90 | 67.90 | 68.00 | 68.40 |
| B₂O₃ | 12.00 | 12.00 | 12.00 | 12.00 | 12.00 | 12.00 | 12.00 | 12.00 | 12.00 | 12.00 | 4.00 | 12.00 |
| Li₂O | 0.00 | 0.00 | 4.00 | 0.00 | 0.00 | 0.00 | 0.00 | 0.00 | 0.00 | 4.00 | 12.00 | 0.00 |
| Na₂O | 0.00 | 0.00 | 0.00 | 0.00 | 0.00 | 0.00 | 0.00 | 0.00 | 0.00 | 0.00 | 0.00 | 0.00 |
| K₂O | 17.00 | 17.00 | 13.00 | 17.00 | 17.00 | 17.00 | 17.00 | 17.00 | 17.00 | 16.00 | 16.00 | 17.00 |
| MgO | 0.00 | 0.00 | 0.00 | 0.00 | 0.00 | 0.00 | 0.00 | 0.00 | 0.00 | 0.00 | 0.00 | 0.00 |
| CaO | 2.50 | 0.00 | 5.00 | 0.00 | 0.00 | 0.00 | 0.00 | 0.00 | 0.00 | 0.00 | 0.00 | 0.00 |
| SrO | 0.00 | 0.00 | 0.00 | 2.50 | 5.00 | 0.00 | 0.00 | 0.00 | 0.00 | 0.00 | 0.00 | 0.00 |
| BaO | 0.00 | 0.00 | 0.00 | 0.00 | 0.00 | 0.00 | 0.00 | 2.50 | 5.00 | 0.00 | 0.00 | 0.00 |
| P₂O₅ | 0.00 | 0.00 | 0.00 | 0.00 | 0.00 | 2.50 | 5.00 | 0.00 | 0.00 | 0.00 | 0.00 | 0.00 |
| ZrO₂ | 0.00 | 0.00 | 0.00 | 0.00 | 0.00 | 0.00 | 0.00 | 0.00 | 0.00 | 0.00 | 0.00 | 2.50 |
| SnO₂ | 0.00 | 0.00 | 0.00 | 0.00 | 0.00 | 0.00 | 0.00 | 0.00 | 0.00 | 0.00 | 0.00 | 0.00 |
| Li₂O + Na₂O + K₂O | 0.10 | 0.10 | 0.10 | 0.10 | 0.10 | 0.10 | 0.10 | 0.10 | 0.10 | 0.10 | 0.10 | 0.10 |
| Li₂O + Na₂O + | 17.0 | 17.0 | 13.0 | 17.0 | 17.0 | 17.0 | 17.0 | 17.0 | 17.0 | 16.0 | 16.0 | 17.0 |
| K₂O—Al₂O₃—B₂O₃—P₂O₅ | | | | | | | | | | | | |
| Bending strain (x 10⁻⁴) | 5.0 | 5.0 | −3.0 | 5.0 | 5.0 | 5.0 | 5.0 | 5.0 | 5.0 | 0.0 | 0.0 | 2.5 |
| SiO₂ | | | | | | | | | | | | |
| Al₂O₃ | | | | | | | | | | | | |
| B₂O₃ | 0.54 | 0.61 | 0.34 | 0.57 | 0.60 | 0.71 | 0.77 | 0.66 | 0.65 | 0.46 | 1.41 | Not |
| (x 10⁻⁴) | | | | | | | | | | | | measured |
| Ps (° C.) | 587 | 561 | 578 | 566 | 570 | 540 | 532 | 552 | 553 | 551 | 538 | 583 |
| Ta (° C.) | 637 | 610 | 628 | 612 | 614 | 585 | 574 | 597 | 595 | 593 | 573 | 635 |
| Ts (° C.) | 883 | 855 | 877 | 838 | 823 | 809 | 782 | 822 | 804 | 801 | 729 | 889 |
| 10^{2.5} dPa · s (° C.) | 1646 | 1681 | 1598 | 1592 | 1528 | 1586 | 1513 | 1599 | 1522 | 1626 | 1264 | 1679 |
| Log η at TL (dPa · s) | Not | 6.2 | Not | 6.0 | 5.2 | 5.6 | 5.5 | 5.7 | 5.3 | 6.0 | >6.2 | 6.7 |
| | measured | | measured | | | | | | | | | |
| CS (MPa) | Not | 710 | Not | 901 | 965 | 740 | 777 | 814 | 881 | 901 | 876 | 714 |
| | measured | | measured | | | | | | | | | |
| DOL (μm) | Not | 43 | Not | 31 | 24 | 26 | 18 | 29 | 21 | 29 | 24 | 72 |
| | measured | | measured | | | | | | | | | |

TABLE 3

| (mol %) | No. 25 | No. 26 | No. 27 | No. 28 | No. 29 | No. 30 | No. 31 | No. 32 | No. 33 | No. 34 | No. 35 | No. 36 |
|---|---|---|---|---|---|---|---|---|---|---|---|---|
| SiO₂ | 66.00 | 68.40 | 66.00 | 61.60 | 61.60 | 64.60 | 64.64 | 61.60 | 61.60 | 69.90 | 69.90 | 69.90 |
| Al₂O₃ | 12.00 | 12.00 | 12.00 | 14.00 | 14.02 | 12.50 | 12.50 | 14.00 | 12.50 | 10.00 | 12.00 | 12.00 |
| B₂O₃ | 0.00 | 0.00 | 0.00 | 4.68 | 4.68 | 4.68 | 4.68 | 4.68 | 4.68 | 6.00 | 6.00 | 2.00 |
| Li₂O | 0.00 | 0.00 | 0.00 | 0.00 | 0.00 | 0.00 | 0.00 | 0.00 | 0.00 | 0.00 | 0.00 | 0.00 |
| Na₂O | 17.00 | 17.00 | 17.00 | 14.06 | 14.06 | 12.60 | 12.60 | 14.06 | 12.60 | 14.00 | 12.00 | 16.00 |
| K₂O | 0.00 | 0.00 | 0.00 | 0.00 | 0.00 | 0.00 | 0.00 | 0.00 | 0.00 | 0.00 | 0.00 | 0.00 |
| MgO | 0.00 | 0.00 | 0.00 | 2.50 | 1.50 | 2.50 | 1.50 | 0.00 | 0.00 | 0.00 | 0.00 | 0.00 |
| CaO | 0.00 | 0.00 | 0.00 | 0.00 | 0.00 | 0.00 | 0.00 | 0.00 | 0.00 | 0.00 | 0.00 | 0.00 |
| SrO | 0.00 | 0.00 | 0.00 | 0.00 | 0.00 | 0.00 | 0.00 | 0.00 | 0.00 | 0.00 | 0.00 | 0.00 |
| BaO | 0.00 | 0.00 | 0.00 | 0.00 | 0.00 | 0.00 | 0.00 | 2.50 | 5.50 | 0.00 | 0.00 | 0.00 |
| P₂O₅ | 5.00 | 0.00 | 0.00 | 3.00 | 3.00 | 3.00 | 3.00 | 3.00 | 3.00 | 0.00 | 0.00 | 0.00 |
| ZrO₂ | 0.00 | 2.50 | 5.00 | 0.00 | 1.00 | 0.00 | 1.00 | 0.00 | 0.00 | 0.00 | 0.00 | 0.00 |
| SnO₂ | 0.10 | 0.10 | 0.10 | 0.10 | 0.10 | 0.10 | 0.10 | 0.10 | 0.10 | 0.10 | 0.10 | 0.10 |
| Li₂O + Na₂O + K₂O | 17.0 | 17.0 | 17.0 | 14.1 | 14.1 | 12.6 | 12.6 | 14.1 | 12.6 | 14.0 | 12.0 | 16.0 |
| Li₂O + Na₂O + | 0.0 | 5.0 | 5.0 | −7.6 | −7.6 | −7.6 | −7.6 | −7.6 | −7.6 | −2.0 | −6.0 | 2.0 |
| K₂O—Al₂O₃—B₂O₃—P₂O₅ | | | | | | | | | | | | |
| Bending strain (x 10⁻⁴) | 0.80 | 0.43 | Not | 0.99 | 1.15 | 0.47 | 0.96 | 1.35 | 1.30 | 0.31 | 0.66 | 0.48 |
| | | | meas- | | | | | | | | | |
| | | | ured | | | | | | | | | |
| Ps (° C.) | 569 | 635 | Not | 568 | 579 | 560 | 569 | 559 | 568 | 548 | 566 | 559 |
| | | | meas- | | | | | | | | | |
| | | | ured | | | | | | | | | |
| Ta (° C.) | 624 | 690 | Not | 623 | 636 | 617 | 627 | 611 | 618 | 590 | 625 | 604 |
| | | | meas- | | | | | | | | | |
| | | | ured | | | | | | | | | |
| Ts (° C.) | 891 | 946 | Not | 903 | 911 | 911 | 910 | 866 | 880 | 791 | 924 | 836 |
| | | | meas- | | | | | | | | | |
| | | | ured | | | | | | | | | |
| 10^{2.5} dPa · s (° C.) | 1661 | 1659 | Not | 1623 | 1624 | 1653 | 1653 | 1640 | 1575 | 1598 | 1718 | 1666 |
| | | | meas- | | | | | | | | | |
| | | | ured | | | | | | | | | |
| Log η at TL (dPa · s) | >8.7 | >9.9 | No | Not | Not | Not | Not | Not | Not | Not | 6.6 | Not |
| | | | meas- | meas- | meas- | meas- | meas- | meas- | meas- | meas- | | meas- |
| | | | ured | ured | ured | ured | ured | ured | ured | ured | | ured |
| CS (MPa) | Not | 1133 | Not | 904 | 953 | 809 | 856 | 854 | 797 | 845 | 904 | 834 |
| | meas- | | meas- | | | | | | | | | |
| | ured | | ured | | | | | | | | | |
| DOL (μm) | Not | 40 | No | 44 | 41 | 45 | 42 | 29 | 26 | 25 | 39 | 34 |
| | meas- | | meas- | | | | | | | | | |
| | ured | | ured | | | | | | | | | |

TABLE 4

| (mol %) | No. 37 | No. 38 | No. 39 | No. 40 | No. 41 | No. 42 | No. 43 | No. 44 | No. 45 | No. 46 | No. 47 | No. 48 |
|---|---|---|---|---|---|---|---|---|---|---|---|---|
| SiO₂ | 69.90 | 69.90 | 69.90 | 69.90 | 70.00 | 65.90 | 65.90 | 65.90 | 65.90 | 65.90 | 65.90 | 65.90 |
| Al₂O₃ | 14.00 | 16.00 | 13.00 | 11.00 | 15.00 | 10.00 | 12.00 | 12.00 | 14.00 | 16.00 | 12.00 | 14.00 |
| B₂O₃ | 2.00 | 2.00 | 4.00 | 4.00 | 4.00 | 6.00 | 6.00 | 2.00 | 2.00 | 2.00 | 6.00 | 6.00 |
| Li₂O | 0.00 | 0.00 | 0.00 | 0.00 | 0.00 | 0.00 | 0.00 | 0.00 | 0.00 | 0.00 | 0.00 | 0.00 |
| Na₂O | 14.00 | 12.00 | 13.00 | 15.00 | 11.00 | 14.00 | 12.00 | 16.00 | 14.00 | 12.00 | 16.00 | 14.00 |
| K₂O | 0.00 | 0.00 | 0.00 | 0.00 | 0.00 | 0.00 | 0.00 | 0.00 | 0.00 | 0.00 | 0.00 | 0.00 |
| MgO | 0.00 | 0.00 | 0.00 | 0.00 | 0.00 | 4.00 | 4.00 | 4.00 | 4.00 | 4.00 | 0.00 | 0.00 |
| CaO | 0.00 | 0.00 | 0.00 | 0.00 | 0.00 | 0.00 | 0.00 | 0.00 | 0.00 | 0.00 | 0.00 | 0.00 |
| SrO | 0.00 | 0.00 | 0.00 | 0.00 | 0.00 | 0.00 | 0.00 | 0.00 | 0.00 | 0.00 | 0.00 | 0.00 |
| BaO | 0.00 | 0.00 | 0.00 | 0.00 | 0.00 | 0.00 | 0.00 | 0.00 | 0.00 | 0.00 | 0.00 | 0.00 |
| P₂O₅ | 0.00 | 0.00 | 0.00 | 0.00 | 0.00 | 0.00 | 0.00 | 0.00 | 0.00 | 0.00 | 0.00 | 0.00 |
| ZrO₂ | 0.00 | 0.00 | 0.00 | 0.00 | 0.00 | 0.00 | 0.00 | 0.00 | 0.00 | 0.00 | 0.00 | 0.00 |
| SnO₂ | 0.10 | 0.10 | 0.10 | 0.10 | 0.10 | 0.10 | 0.10 | 0.10 | 0.10 | 0.10 | 0.10 | 0.10 |
| Li₂O + Na₂O + K₂O | 14.0 | 12.0 | 13.0 | 15.0 | 11.0 | 14.0 | 12.0 | 16.0 | 14.0 | 12.0 | 16.0 | 14.0 |
| Li₂O + Na₂O + | −2.0 | −6.0 | −4.0 | 0.0 | −8.0 | −2.0 | −6.0 | 2.0 | −2.0 | −6.0 | −2.0 | −6.0 |
| K₂O—Al₂O₃—B₂O₃—P₂O₅ | | | | | | | | | | | | |
| Bending strain (x 10⁻⁴) | 0.50 | 0.25 | 0.57 | 0.52 | 0.85 | 0.33 | 0.25 | 0.40 | 0.18 | 0.20 | Not | Not |
| | | | | | | | | | | | meas- | meas- |
| | | | | | | | | | | | ured | ured |
| Ps (° C.) | 634 | 675 | 597 | 554 | 632 | 544 | 566 | 572 | 612 | 652 | 548 | 569 |
| Ta (° C.) | 700 | 744 | 659 | 597 | 700 | 586 | 616 | 621 | 668 | 710 | 588 | 625 |
| Ts (° C.) | 1016 | 1053 | 970 | 809 | 1012 | 797 | 870 | 861 | 935 | 974 | 789 | 911 |
| 10^{2.5} dPa · s (° C.) | 1768 | 1762 | 1744 | 1646 | 1740 | 1539 | 1616 | 1597 | 1646 | 1648 | 1569 | 1675 |
| Log η at TL (dPa · s) | Not | Not | 5.8 | Not | Not | Not | Not | Not | Not | Not | Not | 6.0 |
| | meas- | meas- | | meas- | meas- | meas- | meas- | meas- | meas- | meas- | meas- | |
| | ured | ured | | ured | ured | ured | ured | ured | ured | ured | ured | |
| CS (MPa) | 1132 | 986 | 1032 | 842 | 877 | 895 | 920 | 1039 | 1142 | 1011 | 895 | 1016 |
| DOL (μm) | 54 | 34 | 47 | 29 | 29 | 22 | 26 | 31 | 32 | 23 | 26 | 39 |

TABLE 5

| (mol %) | No. 49 | No. 50 | No. 51 | No. 52 | No. 53 | No. 54 | No. 55 | No. 56 | No. 57 | No. 58 | No. 59 | No. 60 |
|---|---|---|---|---|---|---|---|---|---|---|---|---|
| SiO₂ | 65.90 | 65.90 | 65.90 | 65.90 | 65.90 | 66.00 | 66.00 | 65.90 | 65.90 | 65.90 | 66.00 | 65.90 |
| Al₂O₃ | 16.00 | 18.00 | 10.00 | 12.00 | 14.00 | 12.00 | 14.00 | 17.00 | 19.00 | 17.00 | 19.00 | 10.00 |
| B₂O₃ | 2.00 | 2.00 | 6.00 | 2.00 | 2.00 | 6.00 | 6.00 | 0.00 | 0.00 | 0.00 | 0.00 | 6.00 |
| Li₂O | 0.00 | 0.00 | 0.00 | 0.00 | 0.00 | 2.00 | 2.00 | 0.00 | 0.00 | 2.00 | 2.00 | 0.00 |
| Na₂O | 16.00 | 14.00 | 14.00 | 16.00 | 14.00 | 14.00 | 12.00 | 17.00 | 15.00 | 15.00 | 13.00 | 14.00 |
| K₂O | 0.00 | 0.00 | 0.00 | 0.00 | 0.00 | 0.00 | 0.00 | 0.00 | 0.00 | 0.00 | 0.00 | 0.00 |
| MgO | 0.00 | 0.00 | 0.00 | 0.00 | 0.00 | 0.00 | 0.00 | 0.00 | 0.00 | 0.00 | 0.00 | 0.00 |
| CaO | 0.00 | 0.00 | 0.00 | 0.00 | 0.00 | 0.00 | 0.00 | 0.00 | 0.00 | 0.00 | 0.00 | 0.00 |
| SrO | 0.00 | 0.00 | 0.00 | 0.00 | 0.00 | 0.00 | 0.00 | 0.00 | 0.00 | 0.00 | 0.00 | 0.00 |
| BaO | 0.00 | 0.00 | 0.00 | 0.00 | 0.00 | 0.00 | 0.00 | 0.00 | 0.00 | 0.00 | 0.00 | 4.00 |
| P₂O₅ | 0.00 | 0.00 | 4.00 | 4.00 | 4.00 | 0.00 | 0.00 | 0.00 | 0.00 | 0.00 | 0.00 | 0.00 |
| ZrO₂ | 0.00 | 0.00 | 0.00 | 0.00 | 0.00 | 0.00 | 0.00 | 0.00 | 0.00 | 0.00 | 0.00 | 0.00 |
| SnO₂ | 0.10 | 0.10 | 0.10 | 0.10 | 0.10 | 0.10 | 0.10 | 0.10 | 0.10 | 0.10 | 0.10 | 0.10 |
| Li₂O + Na₂O + K₂O | 16.0 | 14.0 | 14.0 | 16.0 | 14.0 | 16.0 | 14.0 | 17.0 | 15.0 | 17.0 | 15.0 | 14.0 |
| Li₂O + Na₂O + | −2.0 | −6.0 | −6.0 | −2.0 | −6.0 | −2.0 | −6.0 | 0.0 | −4.0 | 0.0 | −4.0 | −2.0 |
| K₂O—Al₂O₃—B₂O₃—P₂O₅ | | | | | | | | | | | | |
| Bending strain (x 10⁻⁴) | Not | Not | Not | Not | Not | Not | Not | 0.31 | 0.16 | 1.42 | 1.14 | Not |
| | meas- | meas- | meas- | meas- | meas- | meas- | meas- | | | | | meas- |
| | ured | ured | ured | ured | ured | ured | ured | | | | | ured |
| Ps (° C.) | 635 | 674 | 514 | 558 | 591 | 509 | 543 | 720 | 739 | 666 | 706 | 541 |
| Ta (° C.) | 699 | 740 | 559 | 610 | 654 | 548 | 596 | 786 | 805 | 727 | 769 | 579 |
| Ts (° C.) | 1001 | 1032 | 793 | 868 | 962 | 743 | 870 | 1067 | 1083 | 1009 | 1038 | 761 |
| 10^{2.5} dPa · s (° C.) | 1718 | 1707 | 1611 | 1663 | 1716 | 1541 | 1644 | 1747 | 1730 | 1704 | 1693 | 1506 |
| Log η at TL (dPa · s) | Not | Not | Not | Not | 6.1 | Not | Not | Not | Not | Not | Not | Not |
| | meas- | meas- | meas- | meas- | | meas- | meas- | meas- | meas- | meas- | meas- | meas- |
| | ured | ured | ured | ured | | ured | ured | ured | ured | ured | ured | ured |
| CS (MPa) | Not | 1124 | 557 | 679 | 772 | Not | Not | Not | Not | Not | Not | 847 |
| | meas- | | | | | meas- | meas- | meas- | meas- | meas- | meas- | |
| | ured | | | | | ured | ured | ured | ured | ured | ured | |
| DOL (μm) | Not | 35 | 46 | 69 | 65 | Not | Not | Not | Not | Not | Not | 11 |
| | meas- | | | | | meas- | meas- | meas- | meas- | meas- | meas- | |
| | ured | | | | | ured | ured | ured | ured | ured | ured | |

TABLE 6

| (mol %) | No. 61 | No. 62 | No. 63 | No. 64 | No. 65 | No. 66 | \|No. 67 | No. 68 | No. 69 | No. 70 | No. 71 | No. 72 |
|---|---|---|---|---|---|---|---|---|---|---|---|---|
| SiO₂ | 65.90 | 65.90 | 65.90 | 65.90 | 63.90 | 63.90 | 66.00 | 65.90 | 66.00 | 63.90 | 64.00 | 65.90 |
| Al₂O₃ | 12.00 | 12.00 | 14.00 | 16.00 | 13.00 | 14.00 | 12.00 | 13.00 | 13.00 | 14.00 | 14.00 | 12.00 |
| B₂O₃ | 6.00 | 2.00 | 2.00 | 2.00 | 8.00 | 8.00 | 6.00 | 8.00 | 8.00 | 6.00 | 6.00 | 6.00 |
| Li₂O | 0.00 | 0.00 | 0.00 | 0.00 | 0.00 | 0.00 | 0.00 | 0.00 | 0.00 | 0.00 | 0.00 | 0.00 |
| Na₂O | 12.00 | 16.00 | 14.00 | 12.00 | 15.00 | 14.00 | 14.00 | 13.00 | 13.00 | 14.00 | 14.00 | 14.00 |
| K₂O | 0.00 | 0.00 | 0.00 | 0.00 | 0.00 | 0.00 | 0.00 | 0.00 | 0.00 | 0.00 | 0.00 | 0.00 |
| MgO | 0.00 | 0.00 | 0.00 | 0.00 | 0.00 | 0.00 | 0.00 | 0.00 | 0.00 | 0.00 | 0.00 | 0.00 |
| CaO | 0.00 | 0.00 | 0.00 | 0.00 | 0.00 | 0.00 | 0.00 | 0.00 | 0.00 | 0.00 | 0.00 | 0.00 |
| SrO | 0.00 | 0.00 | 0.00 | 0.00 | 0.00 | 0.00 | 0.00 | 0.00 | 0.00 | 0.00 | 0.00 | 0.00 |
| BaO | 4.00 | 4.00 | 4.00 | 4.00 | 0.00 | 0.00 | 0.00 | 0.00 | 0.00 | 0.00 | 0.00 | 0.00 |
| P₂O₅ | 0.00 | 0.00 | 0.00 | 0.00 | 0.00 | 0.00 | 2.00 | 0.00 | 0.00 | 2.00 | 2.00 | 2.00 |
| ZrO₂ | 0.00 | 0.00 | 0.00 | 0.00 | 0.00 | 0.00 | 0.00 | 0.00 | 0.00 | 0.00 | 0.00 | 0.00 |
| SnO₂ | 0.10 | 0.10 | 0.10 | 0.10 | 0.10 | 0.10 | 0.10 | 0.10 | 0.10 | 0.10 | 0.10 | 0.10 |
| Li₂O + Na₂O + K₂O | 12.0 | 16.0 | 14.0 | 12.0 | 15.0 | 14.0 | 14.0 | 13.0 | 13.0 | 14.0 | 14.0 | 14.0 |
| Li₂O + Na₂O + | −6.0 | 2.0 | −2.0 | −6.0 | −6.0 | −8.0 | −6.0 | −8.0 | −8.0 | −8.0 | −8.0 | −6.0 |
| K₂O—Al₂O₃—B₂O₃—P₂O₅ | | | | | | | | | | | | |
| Bending strain (x 10⁻⁴) | Not | Not | Not | Not | 0.28 | 0.50 | 0.28 | 0.39 | 0.39 | 0.34 | 0.34 | 0.28 |
| | meas- | meas- | meas- | meas- | | | | | | | | |
| | ured | ured | ured | ured | | | | | | | | |
| Ps (° C.) | 552 | 535 | 573 | 646 | 540 | 553 | 537 | 547 | 547 | 553 | 553 | 537 |
| Ta (° C.) | 595 | 577 | 620 | 708 | 584 | 609 | 585 | 603 | 603 | 609 | 609 | 585 |
| Ts (° C.) | 800 | 779 | 860 | 1002 | 804 | 888 | 832 | 886 | 886 | 898 | 898 | 832 |
| 10^{2.5} dPa · s (° C.) | 1587 | 1539 | 1657 | 1697 | 1598 | 1637 | 1652 | 1663 | 1663 | 1671 | 1671 | 1652 |
| Log η at TL (dPa · s) | Not | Not | Not | Not | 6.1 | 5.8 | 5.3 | 5.5 | 5.7 | <5.2 | 5.8 | <5.6 |
| | meas- | meas- | meas- | meas- | | | | | | | | |
| | ured | ured | ured | ured | | | | | | | | |
| CS (MPa) | 888 | 812 | 983 | 1053 | 898 | 925 | 736 | 866 | 866 | 832 | 832 | 736 |
| DOL (μm) | 12 | 16 | 17 | 21 | 28 | 34 | 39 | 34 | 34 | 42 | 42 | 39 |

TABLE 7

| (mol %) | No. 73 | No. 74 | No. 75 | No. 76 | No. 77 | No. 78 | No. 79 | No. 80 | No. 81 | No. 82 |
|---|---|---|---|---|---|---|---|---|---|---|
| SiO₂ | 65.90 | 59.90 | 63.90 | 63.90 | 63.90 | 63.90 | 64.90 | 64.90 | 44.90 | 66.20 |
| Al₂O₃ | 13.00 | 21.00 | 12.00 | 14.00 | 16.00 | 18.00 | 12.00 | 14.00 | 15.00 | 10.80 |
| B₂O₃ | 6.00 | 0.00 | 6.00 | 6.00 | 2.00 | 2.00 | 6.00 | 6.00 | 0.00 | 9.90 |
| Li₂O | 0.00 | 0.00 | 0.00 | 0.00 | 0.00 | 0.00 | 0.00 | 0.00 | 0.00 | 0.00 |
| Na₂O | 13.00 | 17.00 | 16.00 | 14.00 | 16.00 | 14.00 | 16.00 | 14.00 | 40.00 | 0.00 |
| K₂O | 0.00 | 0.00 | 0.00 | 0.00 | 0.00 | 0.00 | 0.00 | 0.00 | 0.00 | 0.00 |
| MgO | 0.00 | 0.00 | 0.00 | 0.00 | 0.00 | 0.00 | 0.00 | 0.00 | 0.00 | 0.50 |
| CaO | 0.00 | 0.00 | 2.00 | 2.00 | 2.00 | 2.00 | 0.00 | 0.00 | 0.00 | 9.50 |
| SrO | 0.00 | 0.00 | 0.00 | 0.00 | 0.00 | 0.00 | 0.00 | 0.00 | 0.00 | 2.90 |
| BaO | 0.00 | 0.00 | 0.00 | 0.00 | 0.00 | 0.00 | 0.00 | 0.00 | 0.00 | 0.20 |
| P₂O₅ | 2.00 | 2.00 | 0.00 | 0.00 | 0.00 | 0.00 | 0.00 | 0.00 | 0.00 | 0.00 |
| ZrO₂ | 0.00 | 0.00 | 0.00 | 0.00 | 0.00 | 0.00 | 1.00 | 1.00 | 0.00 | 0.00 |
| SnO₂ | 0.10 | 0.10 | 0.10 | 0.10 | 0.10 | 0.10 | 0.10 | 0.10 | 0.10 | 0.10 |
| Li₂O + Na₂O + K₂O | 13.0 | 17.0 | 16.0 | 14.0 | 16.0 | 14.0 | 16.0 | 14.0 | 40.0 | 0.0 |
| Li₂O + Na₂O + | −8.0 | −6.0 | −2.0 | −6.0 | −2.0 | −6.0 | −2.0 | −6.0 | 25.0 | −20.7 |
| K₂O—Al₂O₃—B₂O₃—P₂O₅ | | | | | | | | | | |
| Bending strain (x 10⁻⁴) | 0.28 | Not | Not | Not | Not | Not | Not | Not | 32.00 | 0.30 |
| | | measured | measured | measured | measured | measured | measured | measured | | |
| Ps (° C.) | 549 | 719 | 542 | 556 | 600 | 669 | 552 | 583 | Not | 654 |
| | | | | | | | | | measured | |
| Ta (° C.) | 606 | 782 | 581 | 603 | 653 | 730 | 594 | 642 | Not | 709 |
| | | | | | | | | | measured | |
| Ts (° C.) | 901 | 1045 | 771 | 841 | 918 | 1001 | 804 | 928 | Not | 944 |
| | | | | | | | | | measured | |
| 10^{2.5} dPa · s (° C.) | 1687 | 1662 | 1524 | 1598 | 1652 | 1666 | 1571 | 1654 | Not | 1532 |
| | | | | | | | | | measured | |
| Log η at TL (dPa · s) | 6.9 | 5.4 | 5.5 | Not | Not | Not | Not | Not | Not | 5.7 |
| | | | | measured | measured | measured | measured | measured | measured | |
| CS (MPa) | 770 | 1231 | 930 | 985 | 1142 | 1142 | 975 | 1033 | Not | 0 |
| | | | | | | | | | measured | |
| DOL (μm) | 41 | 46 | 20 | 24 | 34 | 30 | 26 | 37 | Not | 0 |
| | | | | | | | | | measured | |

The strain point Ps and the annealing point Ta refer to values measured by a well-known fiber elongation method. The softening point Ts refers to a value measured by the method of ASTM C338.

The temperature at a high-temperature viscosity of 10^{2.5} dPa·s refers to a value measured by the platinum ball pulling-up method.

The liquid phase viscosity log η at TL is a value obtained by measuring the viscosity of the glass at a liquidus temperature by the platinum ball pulling-up method. The liquidus temperature is a temperature at which crystals precipitate after glass powder that has passed through a standard 30-mesh sieve (500 μm) and remained on a 50-mesh sieve (300 μm) is placed in a platinum boat and then kept in a temperature gradient furnace for 24 hours.

Next, a cylindrical glass with a φ of 6 mm was obtained from the resulting flat sheet-shaped glass through grinding, then a fibrous glass with a length of 150 mm and a φ of 0.13 mm was produced by redrawing and used as an evaluation sample. The bending strain was evaluated using this evaluation sample by the above method.

Next, each sample was optically polished on both surfaces to a sheet thickness of 1.5 mm from the resulting flat sheet-shaped glass and then subjected to ion-exchange treatment by immersing in a KNO₃ molten salt at 430° C. for 4 hours. After the ion-exchange treatment, the surfaces of each sample were washed. The compressive stress value on the outermost surface and the stress depth were calculated from the number of interference fringes and intervals between the fringes observed using a surface stress meter (FSM-6000 available from Orihara Manufacturing Co., Ltd.). The compressive stress value and the stress depth were calculated using a refractive index of 1.50 and an optical elasticity constant of 29.5 [(nm/cm)/MPa] for each sample. Although the glass composition in the surface layer of the glass is microscopically different before and after the ion-exchange treatment, the glass composition is not substantially different in the entire glass.

As is clear from the tables, samples Nos. 1 to 80 had low bending strains and high compressive stress values on the outermost surface. On the other hand, sample No. 81 had a high bending strain. In addition, sample No. 82 had a low bending strain, but the compressive stress layer was not formed, and the compressive stress value on the outermost surface was 0 MPa.

### Example 2

Glass raw materials to give the glass composition of sample No. 1 presented in the table were mixed and melted at 1580° C. for 8 hours using a platinum pot. The resulting molten glass was then poured onto a carbon plate, formed into a flat sheet shape, and annealed at a cooling rate of 2° C./min. A sheet-shaped glass with a sheet thickness of 0.5 mm was obtained from the resulting flat sheet-shaped glass through grinding and polishing, and then a glass sheet to be tempered with a thickness of 50 μm was obtained through slimming by an etching process with hydrofluoric acid. Next, the resulting glass sheet to be tempered was cut into a size of 20×130 mm, then subjected to ion-exchange treatment by immersing in a KNO₃ molten salt at 390° C. for 30 minutes, and a tempered glass sheet was obtained. For the resulting tempered glass sheet, the compressive stress value on the outermost surface and the stress depth were calculated from the number of interference fringes and intervals between the fringes observed using a surface stress meter (FSM-6000 available from Orihara Manufacturing Co., Ltd.). The results showed a compressive stress value on the outermost surface of 1082 MPa and a strain depth of 7.5 μm. In addition, the bending angle measured by the above method was 4.4°. Tempered glass sheets with a similar size can also be obtained for samples Nos. 2 to 80 by a similar method.

### Example 3

A glass batch with the glass composition of sample No. 1 presented in the table was melted in a test melting furnace, and molten glass was each obtained. Then, the molten glass was formed into a glass sheet to be tempered with a sheet thickness of 50 μm by an overflow down-draw method, and the glass sheet was annealed at a cooling rate of 1500° C./min. Next, the resulting glass sheet to be tempered was cut into a size of 20×130 mm, then subjected to ion-exchange treatment by immersing in a KNO₃ molten salt at 390° C. for 30 minutes, and a tempered glass sheet was obtained. For the resulting tempered glass sheet, the compressive stress value on the outermost surface and the stress depth were calculated from the number of interference fringes and intervals between the fringes observed using a surface stress meter (FSM-6000 available from Orihara Manufacturing Co., Ltd.). The results showed a compressive stress value on the outermost surface of 837 MPa and a strain depth of 11.1 μm. In addition, the bending angle measured by the above method was 4.8°. Tempered glass sheets with a similar size can also be obtained for samples Nos. 2 to 80 by a similar method.

### Example 4

A glass batch with the glass composition of sample No. 1 presented in the table was melted in a test melting furnace, and molten glass was each obtained. Then, the molten glass was formed into a glass sheet to be tempered with a sheet thickness of 100 μm by an overflow down-draw method, and the glass sheet was annealed at a cooling rate of 700° C./min. Next, the resulting glass sheet to be tempered was cut into a size of 20×130 mm, then subjected to ion-exchange treatment by immersing in a KNO₃ molten salt at 390° C. for 30 minutes, and a tempered glass sheet was obtained. For the resulting tempered glass sheet, the compressive stress value on the outermost surface and the stress depth were calculated from the number of interference fringes and intervals between the fringes observed using a surface stress meter (FSM-6000 available from Orihara Manufacturing Co., Ltd.). The results showed a compressive stress value on the outermost surface of 945 MPa and a strain depth of 10.2 μm. In addition, the bending angle measured by the above method was 4.1°. Tempered glass sheets with a similar size can also be obtained for samples Nos. 2 to 80 by a similar method.

### Example 5

A glass batch with the glass composition of sample No. 1 presented in the table was melted in a test melting furnace, and molten glass was each obtained. Then, the molten glass was formed into a glass sheet to be tempered with a sheet thickness of 30 μm by an overflow down-draw method, and the glass sheet was annealed at a cooling rate of 2100° C./min. Next, the resulting glass sheet to be tempered was cut into a size of 20×130 mm, then subjected to ion-exchange treatment by immersing in a KNO₃ molten salt at 390° C. for 30 minutes, and a tempered glass sheet was obtained. For the resulting tempered glass sheet, the compressive stress value on the outermost surface and the stress depth were calculated from the number of interference fringes and intervals between the fringes observed using a surface stress meter (FSM-6000 available from Orihara Manufacturing Co., Ltd.). The results showed a compressive stress value on the outermost surface of 699 MPa and a strain depth of 11.7 μm. In addition, the bending angle measured by the above method was 5.0°. Tempered glass sheets with a similar size can also be obtained for samples Nos. 2 to 80 by a similar method.

### INDUSTRIAL APPLICABILITY

The tempered glass sheet according to an embodiment of the present invention is suitable for a glass member, such as that of a foldable display; but also suitable as a cover glass, such as that of a mobile phone, a digital camera, or a PDA; or a glass substrate, such as that for a touch panel display.

1. A tempered glass sheet comprising a compressive stress layer on a surface, the tempered glass sheet having a compressive stress value on an outermost surface of the compressive stress layer of 200 MPa or higher and a bending strain of 30×10⁻⁴ or less.

2. The tempered glass sheet according to claim 1, wherein the compressive stress value on the outermost surface of the compressive stress layer is from 500 to 1200 MPa.

3. The tempered glass sheet according to claim 1, having a sheet thickness of 100 μm or less.

4. The tempered glass sheet according to claim 1, comprising as glass composition in mol % from 40 to 80% of SiO₂, from 5 to 25% of Al₂O₃, from 0 to 30% of B₂O₃, from 0 to 25% of Li₂O, from 0 to 25% of Na₂O, from 0 to 25% of K₂O, from 0 to 20% of MgO, from 0 to 10% of ZnO, from 0 to 15% of P₂O₅, and from 0 to 1% of SnO₂.

5. The tempered glass sheet according to claim 1, wherein a stress depth of the compressive stress layer is from 10 to 30% of the sheet thickness.

6. The tempered glass sheet according to claim 1, having a softening point of 950° C. or lower.

7. The tempered glass sheet according to claim 1, wherein a temperature at a high-temperature viscosity of 10^{2.5} dPa·s is lower than 1650° C.

8. The tempered glass sheet according to claim 1, having a dimension of 50 mm or greater.

9. The tempered glass sheet according to claim 1, comprising an overflow-joining surface in a central portion in a sheet thickness direction.

10. The tempered glass sheet according to claim 1, which is for use in a cover member of a foldable display.

11. A tempered glass sheet comprising a compressive stress layer on a surface, the tempered glass sheet having a compressive stress value on an outermost surface of the compressive stress layer of 200 MPa or higher, a sheet thickness of 100 μm or less, and a bending angle of 30° or less.

12. A glass sheet to be tempered, which is ion-exchangeable and has a bending strain of 30×10⁻⁴ or less.
